(19) United States
(12) Patent Application Publication
(10) Pub. No.: US 2021/0249178 A1
(43) Pub. Date: Aug. 12, 2021

(54) COIL COMPONENT

(71) Applicant: Murata Manufacturing Co., Ltd., Kyoto-fu (JP)

(72) Inventors: Katsuhisa IMADA, Nagaokakyo-shi (JP); Morihiro HAMANO, Nagaokakyo-shi (JP); Makoto HIRAKI, Nagaokakyo-shi (JP); Ryouji MIZOBATA, Nagaokakyo-shi (JP)

(73) Assignee: Murata Manufacturing Co., Ltd., Kyoto-fu (JP)

(21) Appl. No.: 17/168,020

(22) Filed: Feb. 4, 2021

(30) Foreign Application Priority Data
Feb. 6, 2020 (JP) 2020-018934

(51) Int. Cl. H01F 27/28; H01F 27/29; H01F 27/32; H01F 41/04; H01F 41/12

(52) U.S. Cl. CPC H01F 27/2804; H01F 27/29; H01F 2027/2809; H01F 41/043; H01F 41/122; H01F 27/323

(57) ABSTRACT

A highly reliable multilayer coil component, in which the difference in shrinkage ratio between an insulator portion and a conductor portion during firing can be reduced, includes an insulator portion; a coil that is embedded in the insulator portion and includes a plurality of coil conductor layers electrically connected to one another; and outer electrodes that are disposed on surfaces of the insulator portion and are electrically connected to the coil. The coil conductor layers that are adjacent to each other in a stacking direction are connected to each other through a via conductor and a connecting conductor, and the connecting conductor has a pore area ratio smaller than a pore area ratio of the coil conductor layers.

### CROSS-REFERENCE TO RELATED APPLICATION

This application claims benefit of priority to Japanese Patent Application No. 2020-018934, filed Feb. 6, 2020, the entire content of which is incorporated herein by reference.

### BACKGROUND

### Technical Field

The present disclosure relates to a multilayer coil component.

### Background Art

A method for producing a multilayer coil component includes forming a coil pattern on an insulating sheet, stacking these sheets to obtain a multilayer compact, and firing the multilayer compact is known. In this method, coil conductors are connected to each other through via conductors that penetrate the insulating sheets; however, in order to reinforce the connection between the coil conductors and the via conductors, connecting conductors are sometimes formed between the coil conductors and the via conductors, as described, for example, in Japanese Unexamined Patent Application Publication No. 2009-117665.

Since a multilayer coil component such as the one disclosed in Japanese Unexamined Patent Application Publication No. 2009-117665 has a connecting conductor between a coil conductor and a via conductor, the thickness of the conductor layer increases in a portion where the connecting conductor is present. Typically, insulating layers and conductors layers exhibit different shrinkage ratios when fired, and this difference in shrinkage ratio can cause stress inside the multilayer coil component. Due to this stress, the element body may crack and electrical characteristics may vary.

### SUMMARY

The present disclosure includes the following embodiments.

[1] A multilayer coil component including an insulator portion; a coil that is embedded in the insulator portion and includes a plurality of coil conductor layers electrically connected to one another; and outer electrodes that are disposed on surfaces of the insulator portion and are electrically connected to the coil, in which the coil conductor layers that are adjacent to each other in a stacking direction are connected to each other through a via conductor and a connecting conductor. Also, the connecting conductor has a pore area ratio smaller than a pore area ratio of the coil conductor layers.

[2] In the multilayer coil component described in [1], the connecting conductor may have a pore area ratio of 1.0% or more and 4.0% or less (i.e., from 1.0% to 4.0%).

[3] In the multilayer coil component described in [1] or [2], the coil conductor layers may have a pore area ratio of 5.0% or more and 15.0% or less (i.e., from 5.0% to 15.0%).

[4] In the multilayer coil component described in any one of [1] to [3], a portion of the insulator portion may be present in a portion that lies between the coil conductor layer and the connecting conductor connected to that coil conductor layer.

[5] A method for producing a multilayer coil component includes forming a conductive paste layer on an insulating sheet by using a first conductive paste; forming a connecting electrode paste layer on the conductive paste layer by using a second conductive paste; forming an insulating paste layer on a region of the insulating sheet by using an insulating paste, the region being a region where the conductive paste layer is not formed; stacking a plurality of the insulating sheets to form a multilayer compact that includes the conductive paste layers connected into a coil shape; and firing the multilayer compact, in which the second conductive paste has a PVC greater than a PVC of the first conductive paste.

[6] In the method described in [5], the second conductive paste may have a PVC of 80% or more and 90% or less (i.e., from 80% to 90%).

Since the multilayer coil component of the present disclosure includes the connecting conductor having a pore area ratio smaller than the pore area ratio of the via conductor, the difference in shrinkage ratio between the insulator portion and the conductor portion during firing can be reduced. Thus, the multilayer coil component of the present disclosure has high reliability.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a schematic perspective view of a multilayer coil component of the present disclosure;

FIG. 2 is a cross-sectional view of the multilayer coil component illustrated in FIG. 1 taken along line x-x;

FIG. 3 is a cross-sectional view of the multilayer coil component illustrated in FIG. 1 taken along line y-y;

FIGS. 4A to 4F are diagrams illustrating a method for producing the multilayer coil component illustrated in FIG. 1;

FIGS. 5A to 5E are diagrams illustrating the method for producing the multilayer coil component illustrated in FIG. 1;

FIGS. 6A to 6E are diagrams illustrating the method for producing the multilayer coil component illustrated in FIG. 1;

FIGS. 7A to 7E are diagrams illustrating the method for producing the multilayer coil component illustrated in FIG. 1; and

FIG. 8 is a cross-sectional view illustrating a cross-sectional structure of a coil conductor layer, a via conductor, and a connecting conductor of the multilayer coil component of the present disclosure, and the nearby area thereof.

### DETAILED DESCRIPTION

A multilayer coil component 1 according to one embodiment of the present disclosure will now be described in detail by referring to the drawings. The shape, arrangement, and other features of the multilayer coil component of this embodiment and respective constituent elements thereof are not limited by the examples illustrated in the drawings.

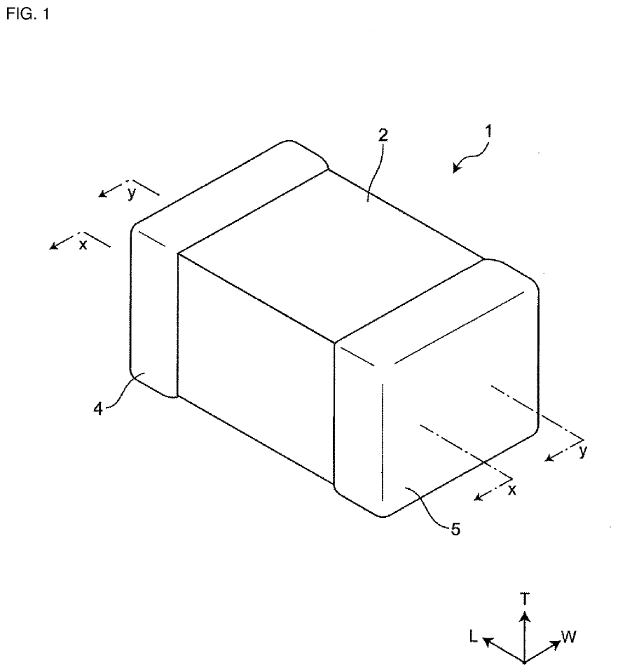

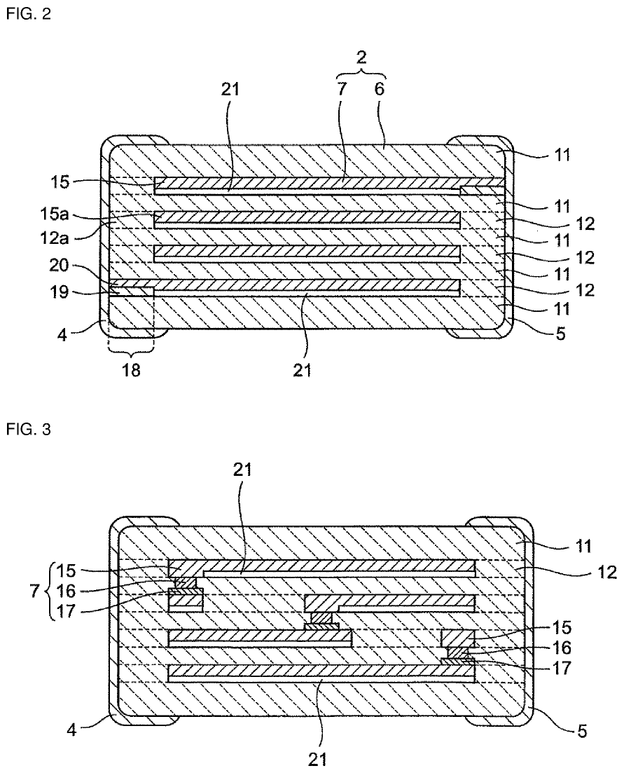

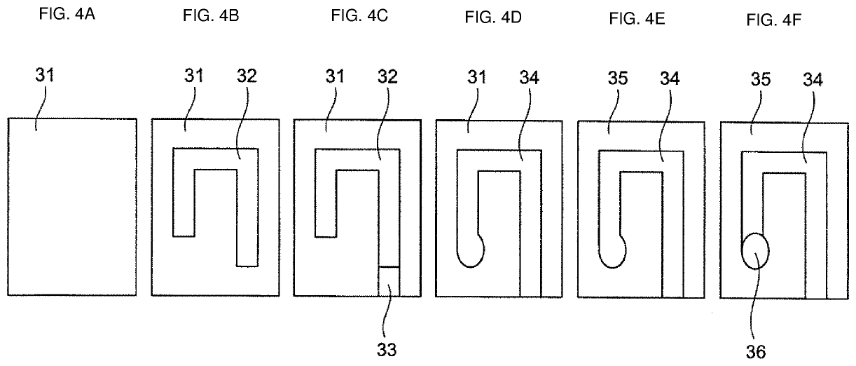

FIG. 1 is a perspective view of a multilayer coil component 1 of this embodiment, FIG. 2 is a cross-sectional view taken along line x-x, and FIG. 3 is a cross-sectional view taken along line y-y. FIGS. 4A to 4F illustrates printing steps performed in producing the multilayer coil component 1. However, the shape, arrangement, and other features of the multilayer coil component of this embodiment and respective constituent elements thereof described below are not limited by the examples illustrated in the drawings.

As illustrated in FIGS. 1 to 3, the multilayer coil component 1 of this embodiment has a substantially rectangular parallelepiped shape. In the multilayer coil component 1, surfaces perpendicular to an L axis in FIG. 1 are referred to as “end surfaces”, surfaces perpendicular to a W axis are referred to as “side surfaces”, and surfaces perpendicular to a T axis are referred to as “upper and lower surfaces”. The multilayer coil component 1 schematically includes an element body 2 and outer electrodes 4 and 5 respectively disposed on two end surfaces of the element body 2. The element body 2 includes an insulator portion 6 and a coil 7 embedded in the insulator portion 6. The insulator portion 6 includes first insulator layers 11 and second insulator layers 12. The coil 7 is constituted by coil conductor layers 15 that are connected into a coil shape by via conductors 16 and connecting conductors 17. The pore area ratio of the connecting conductors 17 is smaller than the pore area ratio of the coil conductor layers 15. The coil 7 has two extended portions 18 respectively at two ends thereof, and is connected to the outer electrodes 4 and 5 via these extended portions. There is a void 21 at the boundary between one of the main surfaces (in FIGS. 2 and 3, the lower main surface) of the coil conductor layer 15 and the insulator portion 6.

The element body 2 of the multilayer coil component 1 of this embodiment includes the insulator portion 6 and the coil 7.

The insulator portion 6 can include the first insulator layers 11 and the second insulator layers 12.

The first insulator layers 11 are each disposed between two coil conductor layers 15 that are adjacent to each other in the stacking direction and between the coil conductor layer 15 and the upper or lower surface of the element body.

The second insulator layer 12 is disposed around the coil conductor layer 15. In other words, the second insulator layer 12 forms a layer that lies at the same height as the coil conductor layer 15 in the stacking direction. For example, in FIG. 2, a second insulator layer 12a is positioned at the same height as the coil conductor layer 15a in the stacking direction.

In one embodiment, the second insulator layer 12 may have a portion that extends over an outer peripheral portion of the coil conductor layer 15. In other words, the second insulator layer 12 may have a portion that covers the outer peripheral portion of the coil conductor layer 15.

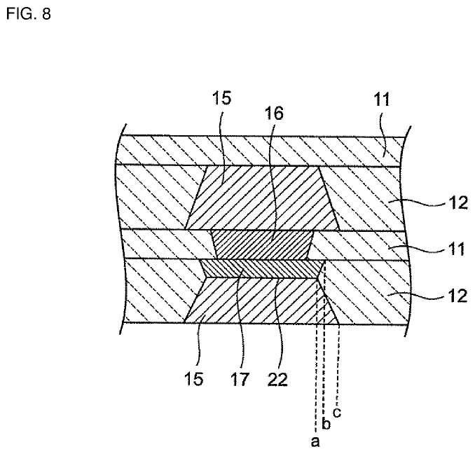

In one embodiment, the second insulator layer 12 can extend to the inner side of the outer edge of the coil conductor layer 15 when one coil conductor layer 15, one second insulator layer 12, and one connecting conductor 17 are viewed in plan from above. In other words, as illustrated in FIG. 8, an edge a of a connecting surface 22 that lies between the coil conductor layer 15 and the connecting conductor 17 is located on the inner side with respect to an edge c of the coil conductor layer 15. Here, the phrase “inner side” refers to a position close to the inside the coil conductor layer 15, for example, a position close to the center of the coil conductor layer 15 as viewed in a cross section illustrated in FIG. 8.

In one embodiment, the second insulator layer 12 can extend to the inner side of the outer edge of the connecting conductor 17 when one coil conductor layer 15, one second insulator layer 12, and one connecting conductor 17 are viewed in plan. In other words, as illustrated in FIG. 8, in a cross section of the multilayer coil component, an edge a of a connecting surface 22 that lies between the coil conductor layer 15 and the connecting conductor 17 is located on the inner side with respect to an edge b of the connecting conductor 17. Here, the phrase “inner side” refers to a position close to the inside of the connecting conductor 17, for example, a position close to the center of the connecting conductor 17 as viewed in a cross section illustrated in FIG. 8.

In a preferred embodiment, the second insulator layer 12 can extend to the inner side of the outer edges of the coil conductor layer 15 and the connecting conductor 17 when one coil conductor layer 15, one second insulator layer 12, and one connecting conductor 17 are viewed in plan. In other words, as illustrated in FIG. 8, in a cross section of the multilayer coil component, the edge a of the connecting surface 22 that lies between the coil conductor layer 15 and the connecting conductor 17 is located on the inner side with respect to the edge c of the coil conductor layer 15 and the edge b of the connecting conductor 17. For example, as illustrated in FIG. 8, the second insulator layer 12 cuts into the coil conductor layer 15 and the connecting conductor 17 in a wedge-like manner.

The first insulator layers 11 and the second insulator layers 12 in the element body 2 may be monolithic. In such a case, the second insulator layer 12 is considered to exist at the same height as the coil conductor layer 15 and the connecting conductor 17.

The insulator portion 6 is preferably formed of a magnetic body and is more preferably formed of sintered ferrite. The sintered ferrite contains, as main components, at least Fe, Ni, and Zn. The sintered ferrite may further contain Cu.

The first insulator layers 11 and the second insulator layers 12 may have the same composition or different compositions. In a preferred embodiment, the first insulator layers 11 and the second insulator layers 12 have the same composition.

In one embodiment, the sintered ferrite contains, as main components, at least Fe, Ni, Zn, and Cu.

In the sintered ferrite described above, the Fe content based on Fe₂O₃ is preferably about 40.0 mol % or more and about 49.5 mol % or less (i.e., from about 40.0 mol % to about 49.5 mol %) (with reference to the total of main components, the same applies hereinafter), and is more preferably about 45.0 mol % or more and about 49.5 mol % or less (i.e., from about 45.0 mol % to about 49.5 mol %).

In the sintered ferrite described above, the Zn content based on ZnO is preferably about 5.0 mol % or more and about 35.0 mol % or less (i.e., from about 5.0 mol % to about 35.0 mol %) (with reference to the total of main components, the same applies hereinafter), and is more preferably about 10.0 mol % or more and about 30.0 mol % or less (i.e., from about 10.0 mol % to about 30.0 mol %).

In the sintered ferrite described above, the Cu content based on CuO is preferably about 4.0 mol % or more and about 12.0 mol % or less (i.e., from about 4.0 mol % to about 12.0 mol %) (with reference to the total of main components, the same applies hereinafter), and is more preferably about 7.0 mol % or more and about 10.0 mol % or less (i.e., from about 7.0 mol % to about 10.0 mol %).

The Ni content in the sintered ferrite described above is not particularly limited, and may be the balance of the aforementioned other main components, Fe, Zn, and Cu.

In one embodiment, the sintered ferrite contains about 40.0 mol % or more and about 49.5 mol % or less of Fe (i.e., from about 40.0 mol % to about 49.5 mol %) based on Fe₂O₃, about 5.0 mol % or more and about 35.0 mol % or less of Zn (i.e., from about 5.0 mol % to about 35.0 mol %) based on ZnO, about 4.0 mol % or more and about 12.0 mol % or less of Cu (i.e., from about 4.0 mol % to about 12.0 mol %) based on CuO, and the balance being NiO.

In the present disclosure, the sintered ferrite may further contain additive components. Examples of the additive components for the sintered ferrite include, but are not limited to, Mn, Co, Sn, Bi, and Si. The Mn, Co, Sn, Bi, and Si contents (added amounts) respectively based on Mn₃O₄, Co₃O₄, SnO₂, Bi₂O₃, and SiO₂ with respect to a total of 100 parts by weight of the main components (Fe (based on Fe₂O₃), Zn (based on ZnO), Cu (based on CuO), and Ni (based on NiO)) are each preferably about 0.1 parts by weight or more and about 1 part by weight or less (i.e., from about 0.1 parts by weight to about 1 part by weight). The sintered ferrite may further contain impurities that are unavoidable during the production.

As described above, the coil 7 is constituted by the coil conductor layers 15 electrically connected to one another into a coil shape. The coil conductor layers 15 that are adjacent to each other in the stacking direction are connected to each other through the via conductor 16 penetrating the insulator portion 6 and through the connecting conductor 17 disposed between the coil conductor layer 15 and the via conductor 16.

The material constituting the coil conductor layers 15 is not particularly limited, and examples thereof include Au, Ag, Cu, Pd, and Ni. The material constituting the coil conductor layers 15 described above is preferably Ag or Cu, and is more preferably Ag. One conductive material or two or more conductive materials may be used.

The via conductor 16 is formed to penetrate through the first insulator layer 11. The material constituting the via conductor 16 can be a material described in relation to the coil conductor layers 15 above. The material constituting the via conductor 16 may be the same as or different from the material constituting the coil conductor layers 15. In a preferred embodiment, the material constituting the via conductor 16 is the same as the material constituting the coil conductor layers 15. In a preferred embodiment, the material constituting the via conductor 16 is Ag.

The connecting conductor 17 is formed in a portion that is on at least the coil conductor layer 15 and where the via conductor 16 is to be connected. For example, when viewed in plan from above, the connecting conductor 17 is formed to include the region where the via conductor 16 that connects to the connecting conductor 17 exists. The material constituting the connecting conductor 17 can be a material described in relation to the coil conductor layers 15 above. The material constituting the connecting conductor 17 may be the same as or different from the material constituting the coil conductor layers 15. In a preferred embodiment, the material constituting the connecting conductor 17 is the same as the material constituting the coil conductor layers 15. In a preferred embodiment, the material constituting the connecting conductor 17 is Ag.

In the multilayer coil component of the present disclosure, the pore area ratio of the connecting conductor 17 is smaller than the pore area ratio of the coil conductor layer 15.

The pore area ratio of the connecting conductor 17 is preferably about 1.0% or more and about 4.0% or less (i.e., from about 1.0% to about 4.0%), more preferably about 1.5% or more and about 3.0% or less (i.e., from about 1.5% to about 3.0%), and yet more preferably about 2.0% or more and about 3.0% or less (i.e., from about 2.0% to about 3.0%). When the pore area ratio of the connecting conductor is within the aforementioned range, cracking of the element body and variation of electrical characteristics can be further suppressed. In addition, spring back that occurs during pressure-bonding of the multilayer body in production can be suppressed.

The pore area ratio of the coil conductor layers 15 is preferably about 5.0% or more and about 15.0% or less (i.e., from about 5.0% to about 15.0%), more preferably about 6.0% or more and about 12.0% or less (i.e., from about 6.0% to about 12.0%), and yet more preferably about 7.0% or more and about 10.0% or less (i.e., from about 7.0% to about 10.0%). When the pore area ratio of the coil conductor layers is within the aforementioned range, cracking of the element body and variation of electrical characteristics can be further suppressed.

In a preferred embodiment, the pore area ratio of the connecting conductor 17 is preferably about 1.0% or more and about 4.0% or less (i.e., from about 1.0% to about 4.0%), more preferably about 1.5% or more and about 3.0% or less (i.e., from about 1.5% to about 3.0%), and yet more preferably about 2.0% or more and about 3.0% or less (i.e., from about 2.0% to about 3.0%), and the pore area ratio of the coil conductor layer 15 is preferably about 5.0% or more and about 15.0% or less (i.e., from about 5.0% to about 15.0%), more preferably about 6.0% or more and about 12.0% or less (i.e., from about 6.0% to about 12.0%), and yet more preferably about 7.0% or more and about 10.0% or less (i.e., from about 7.0% to about 10.0%). When the pore area ratios of the connecting conductor and the coil conductor layer are within the aforementioned ranges, cracking of the element body and variation of electrical characteristics can be further suppressed.

The ratio of the pore area ratio of the connecting conductor to the pore area ratio of the coil conductor layer (pore area ratio of connecting conductor/pore area ratio of coil conductor layer) is preferably about 1/20 to about 4/5, more preferably about 1/15 to about 2/5, and yet more preferably about 1/10 to about 1/5. When this ratio of the pore area ratio is within the aforementioned range, cracking of the element body and variation of electrical characteristics can be further suppressed.

In one embodiment, the connecting conductor is formed of a material having a firing shrinkage ratio of about 5% or more and about 15% or less (i.e., from about 5% to about 15%).

In one embodiment, the coil conductor layer is formed of a material having a firing shrinkage ratio larger than that of the connecting conductor and in the range of about 15% or more and about 20% or less (i.e., from about 15% to about 20%).

In the coil 7 described above, the thickness of the coil conductor layer 15 in the extended portion 18 is larger than the thickness of the coil conductor layer 15 in the winding portion. When the thickness of the coil conductor layer is larger in the extended portion, adhesion between the coil conductor layer in the extended portion and the insulator portion improves.

In this embodiment, the coil conductor layer 15 in the extended portion 18 of the coil 7 described above includes a low-shrinkage layer 19 having a relatively small firing shrinkage ratio and a high-shrinkage layer 20 having a relatively large shrinkage ratio stacked on top of each other. When a low-shrinkage layer having a relatively small firing shrinkage ratio is stacked in the extended portion, shrinkage during firing is suppressed, occurrence of voids between the coil conductor in the extended portion and the insulator portion is suppressed, and thus adhesion between the coil conductor layer in the extended portion and the insulator portion is improved.

Meanwhile, the coil conductor layers 15 in the winding portion of the coil 7 can be high-shrinkage layers having a relatively large firing shrinkage ratio. When the coil conductor layers 15 in the winding portion are obtained by firing high-shrinkage layers having a relatively large firing shrinkage ratio, the voids 21 that serve as stress-alleviating spaces can be formed with higher certainty.

In one embodiment, the low-shrinkage layer 19 is formed of a material having a firing shrinkage ratio of about 5% or more and about 15% or less (i.e., from about 5% to about 15%).

In one embodiment, the high-shrinkage layer 20 is formed of a material having a firing shrinkage ratio larger than that of the low-shrinkage layer 19 and in the range of about 15% or more and about 20% or less (i.e., from about 15% to about 20%).

In the coil conductor layer 15 in the extended portion 18, the ratio of the thickness of the low-shrinkage layer 19 to the thickness of the high-shrinkage layer 20 (low shrinkage layer/high shrinkage layer) is preferably about 0.2 or more and about 1.8 or less (i.e., from about 0.2 or more and about 1.8) and more preferably about 0.2 or more and about 0.8 or less (i.e., from about 0.2 or about 0.8).

The void 21 serves as what is known as a stress-alleviating space. The thickness of the void 21 is preferably about 1 μm or more and about 30 μm or less (i.e., from about 1 μm to about 30 μm) and more preferably about 5 μm or more and about 15 μm or less (i.e., from about 5 μm to about 15 μm).

The thickness of the void 21 is the thickness in the stacking direction and can be measured as follows.

A chip is polished with the LT surface of the chip facing an abrasive paper, and polishing is stopped at the W-dimension center portion in the coil conductor layer. Then the chip is observed with a microscope. The void thickness at the L-dimension center portion in the coil conductor layer is measured by using the measuring function of the microscope.

The outer electrodes 4 and 5 are disposed to cover the two end surfaces of the element body 2. The outer electrodes 4 and 5 are formed of a conductive material, and are preferably formed of at least one metal material selected from Au, Ag, Pd, Ni, Sn, and Cu.

The outer electrodes may each be a single layer or may be multilayered. In one embodiment, each of the outer electrodes is multilayered and is preferably formed of two or more and four or less layers (i.e., from two to four layers), for example, three layers.

In one embodiment, the outer electrodes are multilayered and can each include a Ag- or Pd-containing layer, a Ni-containing layer, or a Sn-containing layer. In a preferred embodiment, the outer electrodes each include a Ag- or Pd-containing layer, a Ni-containing layer, and a Sn-containing layer. Preferably, the aforementioned layers are arranged in the order of, from the coil conductor layer side, a Ag- or Pd-containing layer or preferably a Ag-containing layer, a Ni-containing layer, and a Sn-containing layer. Preferably, the Ag- or Pd-containing layer is a layer obtained by baking a Ag paste or Pd paste, and the Ni-containing layer and the Sn-containing layer can be plating layers.

The multilayer coil component of the present disclosure preferably has a length of about 0.4 mm or more and about 3.2 mm or less (i.e., from about 0.4 mm to about 3.2 mm), a width of about 0.2 mm or more and about 2.5 mm or less (i.e., from about 0.2 mm to about 2.5 mm), and a height of about 0.2 mm or more and about 2.0 mm or less (i.e., from about 0.2 mm to about 2.0 mm), and more preferably has a length of about 0.6 mm or more and about 2.0 mm or less (i.e., from about 0.6 mm to about 2.0 mm), a width of about 0.3 mm or more and about 1.3 mm or less (i.e., from about 0.3 mm to about 1.3 mm), and a height of about 0.3 mm or more and about 1.0 mm or less (i.e., from about 0.3 mm to about 1.0 mm).

The multilayer coil component 1 of the embodiment described above is produced as follows, for example. In this embodiment, an example in which the insulator portion 6 is formed from a ferrite material is described.

(1) Preparation of Ferrite Paste

First, a ferrite material is prepared. The ferrite material contains, as main components, Fe, Zn, and Ni, and, if desired, Cu. Typically, the main components of the ferrite material are practically oxides of Fe, Zn, Ni, and Cu (ideally, Fe₂O₃, ZnO, NiO, and CuO).

To prepare the ferrite material, Fe₂O₃, ZnO, CuO, NiO, and, if needed, additive components are weighed to obtain a particular composition, and then mixed and pulverized. The pulverized ferrite material is dried and calcined at, for example, a temperature of about 700° C. to about 800° C. so as to obtain a calcined powder. To this calcined powder, particular amounts of a solvent (ketone solvent or the like), a resin (polyvinyl acetal or the like), and a plasticizer (alkyd plasticizer or the like) are added, the resulting mixture is kneaded in a planetary mixer or the like, and the kneaded mixture is dispersed with a three-roll mill or the like to prepare a ferrite paste.

(2) Preparation of Ferrite Sheets

Next, to a calcined powder of a ferrite material obtained in the same manner as that described above, an organic binder such as a polyvinyl butyral binder, and an organic solvent such as ethanol or toluene are added, and the resulting mixture is put in a pot mill along with PSZ balls to be mixed and pulverized. The obtained mixture is then formed into sheets having particular thickness, size, and shape by a doctor blade method or the like. As a result, ferrite sheets can be prepared.

In the ferrite material described above, the Fe content based on Fe₂O₃ is preferably about 40.0 mol % or more and about 49.5 mol % or less (i.e., from about 40.0 mol % to about 49.5 mol %) (with reference to the total of main components, the same applies hereinafter), and is more preferably about 45.0 mol % or more and about 49.5 mol % or less (i.e., from about 45.0 mol % to about 49.5 mol %).

In the ferrite material described above, the Zn content based on ZnO is preferably about 5.0 mol % or more and about 35.0 mol % or less (i.e., from about 5.0 mol % to about 35.0 mol %) (with reference to the total of main components, the same applies hereinafter), and is more preferably about 10.0 mol % or more and about 30.0 mol % or less (i.e., from about 10.0 mol % to about 30.0 mol %).

In the ferrite material described above, the Cu content based on CuO is preferably about 4.0 mol % or more and about 12.0 mol % or less (i.e., from about 4.0 mol % to about 12.0 mol %) (with reference to the total of main components, the same applies hereinafter), and is more preferably about 7.0 mol % or more and about 10.0 mol % or less (i.e., from about 7.0 mol % to about 10.0 mol %).

The Ni content in the ferrite material described above is not particularly limited, and can be the balance of the aforementioned other main components, Fe, Zn, and Cu.

In one embodiment, the ferrite material contains about 40.0 mol % or more and about 49.5 mol % or less of Fe (i.e., from about 40.0 mol % to about 49.5 mol %) based on Fe₂O₃, about 5.0 mol % or more and about 35.0 mol % or less of Zn (i.e., from about 5.0 mol % to about 35.0 mol %) based on ZnO, about 4.0 mol % or more and about 12.0 mol % or less of Cu (i.e., from about 4.0 mol % to about 12.0 mol %) based on CuO, and the balance being NiO.

In the present disclosure, the ferrite material may further contain additive components. Examples of the additive components for the ferrite material include, but are not limited to, Mn, Co, Sn, Bi, and Si. The Mn, Co, Sn, Bi, and Si contents (added amounts) respectively based on Mn₃O₄, Co₃O₄, SnO₂, Bi₂O₃, and SiO₂ with respect to a total of 100 parts by weight of the main components (Fe (based on Fe₂O₃), Zn (based on ZnO), Cu (based on CuO), and Ni (based on NiO)) are each preferably about 0.1 parts by weight or more and about 1 part by weight or less (i.e., from about 0.1 parts by weight to about 1 part by weight). The ferrite material may further contain impurities that are unavoidable during the production.

The Fe content (based on Fe₂O₃), the Mn content (based on Mn₂O₃), the Cu content (based on CuO), the Zn content (based on ZnO), and the Ni content (based on NiO) in the sintered ferrite may be considered to be substantially the same as the Fe content (based on Fe₂O₃), the Mn content (based on Mn₂O₃), the Cu content (based on CuO), the Zn content (based on ZnO), and the Ni content (based on NiO) in the ferrite material before firing.

(3) Preparation of Conductive Paste for Coil Conductor

First, a conductive material is prepared. Examples of the conductive material include Au, Ag, Cu, Pd, and Ni, of which Ag or Cu is preferable and Ag is more preferable. A particular amount of a powder of the conductive material is weighed and kneaded along with particular amounts of a solvent (such as eugenol), a resin (such as ethyl cellulose), and a dispersant in a planetary mixer or the like, and then the resulting mixture is dispersed in a three-roll mill or the like. As a result, a conductive paste for the coil conductor can be prepared.

When preparing the conductive paste described above, the pigment volume concentration (PVC) which is the concentration of the volume of the conductive material relative to the total volume of the conductive material (typically, a silver powder) and the resin component in the conductive paste is adjusted so as to prepare two types of conductive pastes (high-shrinkage conductive paste (A) and low-shrinkage conductive paste (B)) that exhibit different shrinkage ratios when fired (hereinafter, these shrinkage ratios are referred to as “firing shrinkage ratios”).

The firing shrinkage ratio of the high-shrinkage conductive paste is preferably about 15% or more and about 20% or less (i.e., from about 15% to about 20%).

The firing shrinkage ratio of the low-shrinkage conductive paste is preferably about 5% or more and about 15% or less (i.e., from about 5% to about 15%).

The PVC of the high-shrinkage conductive paste is preferably about 50% or more and about 80% or less (i.e., from about 50% to about 80%) and more preferably about 60% or more and about 70% or less (i.e., from about 60% to about 70%).

The PVC of the low-shrinkage conductive paste is preferably about 80% or more and about 90% or less (i.e., from about 80% to about 90%) and more preferably about 82% or more and about 88% or less (i.e., from about 82% to about 88%).

Here, the shrinkage ratio can be determined by applying the conductive paste to a polyethylene terephthalate (PET) film, drying the applied paste, cutting the dried paste into a size of about 5 mm×5 mm, and then measuring the change in dimension of the resulting sample by using a thermomechanical analyzer (TMA).

The PVC can be determined by measuring the weight ratio between the conductive material and the resin component by thermogravimetry (TG) and then determining the PVC from the densities of the conductive material and the resin component.

(4) Preparation of Resin Paste

A resin paste for forming the voids 21 in the multilayer coil component 1 is prepared. The resin paste can be prepared by adding, to a solvent (such as isophorone), a resin (such as an acrylic resin) that disappears when fired.

(5) Preparation of Multilayer Coil Component

(5-1) Preparation of Element Body

First, a ferrite sheet 31 is prepared (FIG. 4A).

Next, the resin paste is applied by printing to a portion where the void 21 is to be formed (in other words, a portion where the coil conductor layer is to be formed except for portions where the extended portion and the via are to be formed) so as to form a resin paste layer 32 (FIG. 4B).

Next, the low-shrinkage conductive paste is applied by printing to a portion where the extended portion is to be formed so as to form a low-shrinkage conductive paste layer 33 (FIG. 4C).

Next, the high-shrinkage conductive paste is applied by printing to the entirety of the portion where the coil conductor layer is to be formed so as to form a high-shrinkage conductive paste layer 34 (FIG. 4D).

Next, the ferrite paste described above is applied by printing to the region where the high-shrinkage conductive paste layer 34 is not formed so that the applied ferrite paste has the same height as the high-shrinkage conductive paste layer 34, thereby forming a ferrite paste layer 35 (FIG. 4E).

Next, the low-shrinkage conductive paste is applied by printing to the portion to be connected to the via conductor so as to form a connecting electrode paste layer 36 (FIG. 4F).

A first pattern sheet is formed by the aforementioned process.

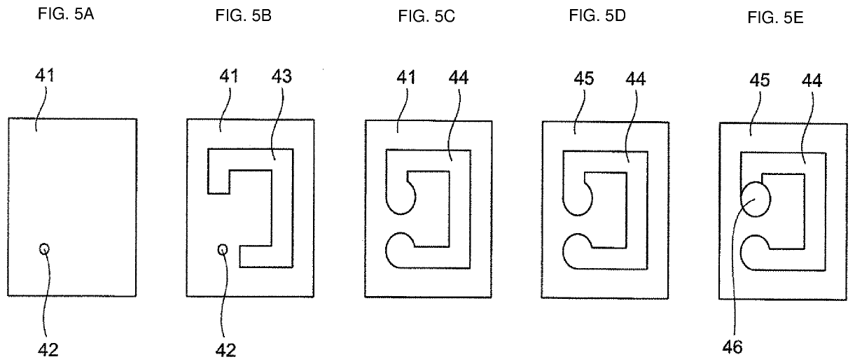

Another ferrite sheet 41 is separately prepared. A via hole 42 is formed in a particular portion of the ferrite sheet 41 (FIG. 5A).

Next, the resin paste is applied by printing to a portion where the void 21 is to be formed so as to form a resin paste layer 43 (FIG. 5B).

Next, the high-shrinkage conductive paste is applied by printing to the entirety of the portion where the coil conductor layer is to be formed so as to form a high-shrinkage conductive paste layer 44 (FIG. 5C).

Next, the ferrite paste described above is applied by printing to the region where the high-shrinkage conductive paste layer 44 is not formed so that the applied ferrite paste has the same height as the high-shrinkage conductive paste layer 44, thereby forming a ferrite paste layer 45 (FIG. 5D).

Next, the low-shrinkage conductive paste is applied by printing to the portion to be connected to the via conductor so as to form a connecting electrode paste layer 46 (FIG. 5E).

A second pattern sheet is formed by the aforementioned process.

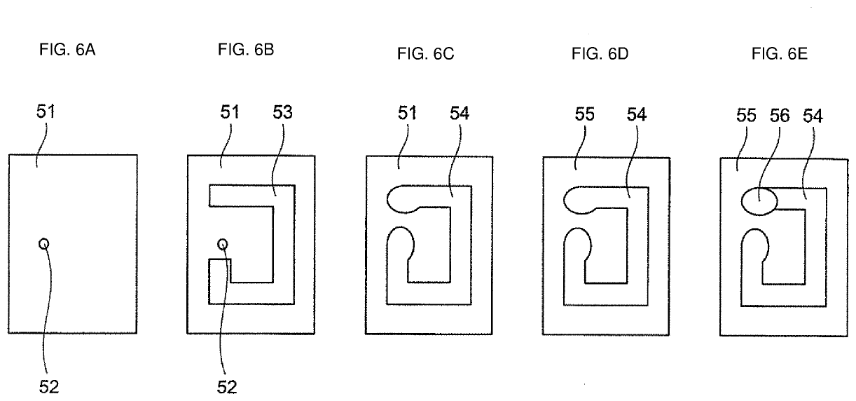

Another ferrite sheet 51 is prepared separately, and, as with the pattern sheet described above, a via hole 52, a resin paste layer 53, a high-shrinkage conductive paste layer 54, a ferrite paste layer 55, and a connecting electrode paste layer 56 are formed to obtain a third pattern sheet (FIGS. 6A to 6E).

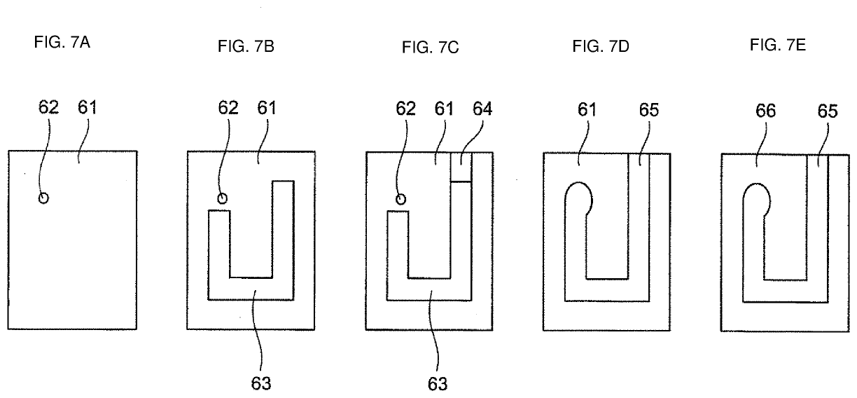

Another ferrite sheet 61 is prepared separately, and, as with the pattern sheet described above, a via hole 62, a resin paste layer 63, a low-shrinkage conductive paste layer 64, a high-shrinkage conductive paste layer 65, and a ferrite paste layer 66 are formed to obtain a fourth pattern sheet (FIGS. 7A to 7E).

The first to fourth pattern sheets prepared as such are stacked on top of each other in this order to form a stack, two ferrite sheets with nothing printed thereon are respectively placed on the top and the bottom of the stack, and the resulting stack is thermally pressure-bonded to form a multilayer body block. The multilayer body block is cut by using a dicer or the like to obtain individual pieces.

The obtained element is subjected to a barrel process to round the corners of the element. The barrel process may be performed on a green multilayer body or a fired multilayer body. The barrel process may be a dry process or a wet process. The barrel process may involve scrubbing the elements against each other or performing the barrel process along with media.

After the barrel process, for example, the element is fired at a temperature of about 880° C. or higher and about 920° C. or lower (i.e., from about 880° C. to about 920° C.) to obtain an element body 2 of the multilayer coil component 1.

(5-2) Formation of Outer Electrodes

Next, an outer electrode-forming Ag paste containing Ag and glass is applied to the end surfaces of the element body 2 and baked to form base electrodes. Next, a Ni coating and a Sn coating are sequentially formed on each of the base electrodes by electrolytic plating to form outer electrodes. As a result, a multilayer coil component 1 as illustrated in FIG. 1 is obtained.

The present disclosure provides the aforementioned production method, specifically, a method for producing a multilayer coil component, the method including forming a conductive paste layer on an insulating sheet by using a first conductive paste; forming a connecting electrode paste layer on the conductive paste layer by using a second conductive paste; forming an insulating paste layer on a region of the insulating sheet by using an insulating paste, the region being a region where the conductive paste layer is not formed; stacking a plurality of the insulating sheets to form a multilayer compact that includes the conductive paste layers connected into a coil shape; and firing the multilayer compact, in which the second conductive paste has a PVC greater than a PVC of the first conductive paste. The PVC of the second conductive paste is larger than the PVC of the first conductive paste.

In a preferred embodiment, the PVC of the second conductive paste is about 80% or more and about 90% or less (i.e., from about 80% to about 90%) and more preferably about 82% or more and about 88% or less (i.e., from about 82% to about 88%).

In a preferred embodiment, the PVC of the first conductive paste is preferably about 50% or more and about 80% or less (i.e., from about 50% to about 80%) and more preferably about 60% or more and about 70% or less (i.e., from about 60% to about 70%).

One embodiment of the present disclosure has been described heretofore, but the present embodiment is subject to various modifications.

### EXAMPLES

### Example

Preparation of Ferrite Paste

Fe₂O₃, ZnO, CuO, and NiO powders were respectively weighed into 49.0 mol %, 25.0 mol %, 8.0 mol %, and the balance with respect to the total of these powders. The powders were then placed in a ball mill along with PSZ media, pure water, and a dispersant, wet-mixed, pulverized, dried, and calcined at 700° C. to obtain a calcined powder. To the calcined powder, particular amounts a ketone solvent, polyvinyl acetal, and an alkyd plasticizer were added, the resulting mixture was kneaded in a planetary mixer, and then the kneaded mixture was further dispersed with a three-roll mill to prepare a ferrite paste.

Preparation of Ferrite Sheets

The ferrite material was weighed so that the composition thereof was the same as the ferrite paste described above. The weighed material was placed in a ball mill along with PSZ media, pure water, and a dispersant, wet-mixed, pulverized, dried, and calcined at a temperature of 700° C. to obtain a calcined powder. The obtained calcined powder, a polyvinyl butyral organic binder, ethanol, and toluene were placed in a pot mill along with PSZ balls, and were mixed and pulverized. The obtained mixture was formed into sheets by a doctor blade method. As a result, ferrite sheets were prepared.

Preparation of Conductive Paste for Coil Conductor

A particular amount of a silver powder was prepared as a conductive material and was kneaded in a planetary mixer along with eugenol, ethyl cellulose, and a dispersant, and the resulting mixture was dispersed in a three-roll mill to prepare a conductive paste for a coil conductor.

When preparing the conductive paste described above, the PVC was adjusted to prepare two conductive pastes (A) and (B) having different firing shrinkage ratios.

(A) High-shrinkage conductive paste (a shrinkage ratio of 15% at 800° C.)

(B) Low-shrinkage conductive paste (a shrinkage ratio of 10% at 800° C.)

Preparation of Resin Paste

Isophorone and an acrylic resin were mixed to prepare a resin paste.

Preparation of Multilayer Coil Component

By using the ferrite sheets, the ferrite paste, the high-shrinkage conductive paste, the low-shrinkage conductive paste, and the resin paste described above, pattern sheets were prepared by the process illustrated in FIGS. 4A to 7E, and the pattern sheets were pressure-bonded to form an assembly, which was a multilayer body block.

Next, the multilayer body block was cut by using a dicer or the like to obtain individual elements. The obtained element was subjected to a barrel process to round the corners of the element. After the barrel process, the element was fired at a temperature of 920° C. to obtain an element body.

Next, an outer electrode-forming Ag paste containing Ag and glass was applied to the end surfaces of the element body and baked to form base electrodes. Next, a Ni coating and a Sn coating were sequentially formed on each of the base electrodes by electrolytic plating so as to form outer electrodes. As a result, a multilayer coil component of Example was obtained.

### Comparative Example 1

A multilayer coil component of Comparative Example 1 was obtained as in Example described above except that forming of the connecting electrode paste layers 36, 46, and 56 illustrated in FIGS. 4A to 6E was omitted.

### Comparative Example 2

A multilayer coil component of Comparative Example 2 was obtained as in Example described above except that the connecting electrode paste layers 36, 46, and 56 illustrated in FIGS. 4A to 6E were formed by using the high-shrinkage conductive paste.

The samples (multilayer coil components) of Example and Comparative Examples all had a length (L) of 1.0 mm, a width (W) of 0.5 mm, and a height (T) of 0.5 mm

Evaluation

One hundred multilayer coil components of Example, one hundred multilayer coil components of Comparative Example 1, and one hundred multilayer coil components of Comparative Example 2 obtained as above were evaluated as to whether there was cracking. The result is shown in the table below. The presence of cracking was confirmed by polishing the LT surface, stopping polishing at about the position where the connecting conductor and the via conductor illustrated in FIG. 3 are exposed, and observing the polished surface with a digital microscope.

TABLE

| | Number of cracks |
|---|---|
| Example | 0 |
| Comparative Example 1 | 100 |
| Comparative Example 2 | 100 |

A multilayer coil component of the present disclosure can be used in a variety of usages including inductors.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A multilayer coil component comprising:
an insulator portion;
a coil that is embedded in the insulator portion and includes a plurality of coil conductor layers electrically connected to one another, the coil conductor layers that are adjacent to each other in a stacking direction being connected to each other through a via conductor and a connecting conductor, and the connecting conductor having a pore area ratio smaller than a pore area ratio of the coil conductor layers; and
outer electrodes that are disposed on surfaces of the insulator portion and are electrically connected to the coil.

2. The multilayer coil component according to claim 1, wherein
the connecting conductor has a pore area ratio of from 1.0% to 4.0%.

3. The multilayer coil component according to claim 1, wherein
the coil conductor layers have a pore area ratio of from 5.0% to 15.0%.

4. The multilayer coil component according to claim 1, wherein
a portion of the insulator portion is present in a portion that lies between the coil conductor layer and the connecting conductor connected to that coil conductor layer.

5. The multilayer coil component according to claim 2, wherein
the coil conductor layers have a pore area ratio of from 5.0% to 15.0%.

6. The multilayer coil component according to claim 2, wherein
a portion of the insulator portion is present in a portion that lies between the coil conductor layer and the connecting conductor connected to that coil conductor layer.

7. The multilayer coil component according to claim 3, wherein
a portion of the insulator portion is present in a portion that lies between the coil conductor layer and the connecting conductor connected to that coil conductor layer.

8. The multilayer coil component according to claim 5, wherein
a portion of the insulator portion is present in a portion that lies between the coil conductor layer and the connecting conductor connected to that coil conductor layer.

9. A method for producing a multilayer coil component, the method comprising:
forming a conductive paste layer on an insulating sheet by using a first conductive paste;
forming a connecting electrode paste layer on the conductive paste layer by using a second conductive paste having a PVC greater than a PVC of the first conductive paste;
forming an insulating paste layer on a region of the insulating sheet by using an insulating paste, the region being a region where the conductive paste layer is not formed;
stacking a plurality of the insulating sheets to form a multilayer compact that includes the conductive paste layers connected into a coil shape; and
firing the multilayer compact.

10. The method for producing a multilayer coil component according to claim 9, wherein
the second conductive paste has a PVC of from 80% to 90%.
